(19) United States
(12) Patent Application Publication
(10) Pub. No.: US 2025/0133999 A1
(43) Pub. Date: May 1, 2025

(54) SYSTEM AND METHOD FOR DETERMINING THE CLUTCH STATUS OF AN AGRICULTURAL BALER

(71) Applicant: CNH Industrial America LLC, New Holland, PA (US)

(72) Inventor: Noah Scott Pendry, Boonville, NC (US)

(21) Appl. No.: 18/495,927

(22) Filed: Oct. 27, 2023

(51) Int. Cl. A01D 89/00; A01F 15/07; A01F 15/10; F16D 48/06

(52) U.S. Cl. CPC A01D 89/005; A01F 15/07; A01F 15/106; F16D 48/06; F16D 2500/10437

(57) ABSTRACT

A system for determining the clutch status of a baler includes a crop collector and a drive assembly configured to rotationally drive the crop collector. The drive assembly includes a drive shaft and an output shaft coupled between the crop collector and the drive shaft. The drive assembly also includes a clutch coupled between the drive shaft and the output shaft and moveable between an engaged position and a disengaged position to mechanically couple and decouple the drive shaft and the output shaft from each other. The system also includes a sensor configured to generate data indicative of a rotational movement of the output shaft. Furthermore, the system includes a computing system configured to determine a rotational speed of the output shaft based on the data generated by the sensor and determine when the clutch is in the disengaged position based on the determined rotational speed of the output shaft.

### FIELD OF THE INVENTION

The present subject matter relates generally to agricultural balers and, more particularly, to systems and methods for determining the clutch status of an agricultural baler during a baling operation.

### BACKGROUND OF THE INVENTION

A baler is an agricultural implement towed behind a work vehicle (e.g., an agricultural tractor) to perform a baling operation on a field. In general, during a baling operation, crop material deposited within a field is collected and packed together to form a single crop material unit called a bale. More specifically, upon completion of a cutting operation or windrowing operation, swaths or windrows of crop material (e.g., hay) are present on the surface of the field. As such, during a baling operation, the baler is towed across the field to collect the crop material and produce bales. For instance, the baler may collect the crop material via a crop collector located at the front of the baler and deliver such crop material to a baling chamber of the baler. Once received within the baling chamber, the crop material is compacted into a bale of a predetermined shape (e.g., a round bale or a square/rectangular bale). The resulting bale is then ejected from the rear of the baler and deposited within the field.

During the performance of a baling operation, the baler may become jammed or plugged, such as when excess crop material falls between components, such as belt rollers, of the baler. Such jamming or plugging causes a clutch of the baler to disengage, thereby halting rotation of various components of the baler. When such components cease rotating, the baler no longer forms bales. However, it may be difficult for operators to determine when the clutch of the baler has disengaged, particularly in dusty conditions.

Accordingly, a system and a method for determining the clutch status of an agricultural baler would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for determining the clutch status of an agricultural baler. The system includes a crop collector configured to lift crop material from a field surface. Additionally, the system includes a drive assembly configured to rotationally drive the crop collector. The drive assembly includes a drive shaft and an output shaft coupled between the crop collector and the drive shaft. Moreover, the drive assembly includes a clutch coupled between the drive shaft and the output shaft. The clutch is moveable between an engaged position and a disengaged position such that, when the clutch is in the engaged position, the drive shaft is mechanically coupled to the drive shaft and, when the clutch is in the disengaged position, the drive shaft is mechanically decoupled from the output shaft. Additionally, the system includes a sensor configured to generate data indicative of a rotational movement of the output shaft. Furthermore, the system includes a computing system communicatively coupled to the sensor. The computing system is configured to determine a rotational speed of the output shaft based on the data generated by the sensor. Moreover, the computing system is configured to determine when the clutch is in the disengaged position based on the determined rotational speed of the output shaft.

In another aspect, the present subject matter is directed to a method for determining the clutch status of an agricultural baler. The agricultural baler includes a crop collector configured to lift crop material from a field surface. Additionally, the agricultural baler includes a drive assembly configured to rotationally drive the crop collector. The drive assembly includes a drive shaft and an output shaft coupled between the crop collector and the drive shaft. The method includes receiving, with a computing system, sensor data indicative of a rotational movement of the output shaft. Furthermore, the method includes determining, with the computing system, a rotational speed of the output shaft based on the received sensor data. Moreover, the method includes determining, with the computing system, when a clutch, moveable between an engaged position in which the drive shaft is mechanically coupled to the output shaft and a disengaged position in which the drive shaft is mechanically decoupled from the output shaft, is in a disengaged position based on the determined rotational speed of the output shaft. Additionally, the method includes initiating, with the computing system, a control action when it is determined that the clutch is in the disengaged position.

In a further aspect, the present subject matter is directed to an agricultural baler. The agricultural baler includes a crop collector configured to lift crop material from a field surface. Additionally, the agricultural baler includes a bale housing defining a bale chamber therein. Furthermore, the agricultural baler includes a plurality of carrier elements configured to form a bale of the lifted crop material. Additionally, the agricultural baler includes a drive assembly configured to rotationally drive the crop collector. The drive assembly includes a drive shaft and an output shaft coupled between the crop collector and the drive shaft. Moreover, the drive assembly includes a clutch coupled between the drive shaft and the output shaft. The clutch is moveable between an engaged position and a disengaged position such that, when the clutch is in the engaged position, the drive shaft is mechanically coupled to the drive shaft and, when the clutch is in the disengaged position, the drive shaft is mechanically decoupled from the output shaft. Additionally, the system includes a sensor configured to generate data indicative of a rotational movement of the output shaft. Furthermore, the system includes a computing system communicatively coupled to the sensor. The computing system is configured to determine a rotational speed of the output shaft based on the data generated by the sensor. Moreover, the computing system is configured to determine when the clutch is in the disengaged position based on the determined rotational speed of the output shaft.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of a work vehicle towing an agricultural baler in accordance with aspects of the present subject matter;

FIG. 2 illustrates a cross-sectional side view of one embodiment of an agricultural baler in accordance with aspects of the present subject matter;

FIG. 3 illustrates a perspective view of one embodiment of a drive assembly of the agricultural baler in accordance with aspects of the present subject matter;

FIG. 4 illustrates a schematic view of one embodiment of a system for determining the clutch status of an agricultural baler in accordance with aspects of the present subject matter;

FIG. 5 illustrates a flow diagram of one embodiment of control logic for determining the clutch status of an agricultural baler in accordance with aspects of the present subject matter; and

FIG. 6 illustrates a flow diagram of one embodiment of a method for determining the clutch status of an agricultural baler in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and a method for determining the clutch status of an agricultural baler. As will be described below, the agricultural baler includes a crop collector, such as a rotatable pickup reel, configured to lift crop material, such as hay, from the surface of a field. Additionally, the agricultural baler includes a drive assembly configured to rotationally drive the crop collector. The drive assembly includes a drive shaft configured to be driven by a power-take-off (PTO) of a work vehicle and an output shaft coupled between the crop collector and the drive shaft. Furthermore, the drive assembly includes a clutch moveable between an engaged position and a disengaged position. Specifically, when the clutch is in the engaged position, the drive shaft is mechanically coupled to the output shaft such that the drive assembly rotationally drives the crop collector. Conversely, when the clutch is in the disengaged position, the drive shaft is mechanically decoupled from the output shaft such that the drive assembly is prevented from driving the crop collector.

Additionally, a computing system of the disclosed system is configured to determine when the clutch is at the disengaged position. More specifically, the computing system is configured to receive sensor data indicative of the rotational movement of the output shaft. As such, the computing system may determine the rotational speed of the output shaft based on the received sensor data. Thereafter, the computing system may determine when the clutch is in the disengaged position based on the determined rotational speed of the output shaft, such as when the output shaft is stationary.

Furthermore, in some optional embodiments, the computing system is configured to determine when the clutch is in the disengaged position based on the determined rotational speed of the drive shaft and the determined rotational speed of the output shaft. In such embodiments, the computing system may be configured to receive first sensor data indicative of the rotational movement of the output shaft and second sensor data indicative of the rotational movement of the drive shaft. As such, the computing system may be configured to determine the rotational speeds of the drive shaft and the output shaft based on the received first and second sensor data. Additionally, the computing system may be configured to compare the rotational speed of the drive shaft to the rotational speed of the output shaft. Moreover, the computing system may be configured to determine that the clutch is in the disengaged position when rotational speed of the drive shaft exceeds the rotational speed of the output shaft by a predetermined threshold. Thereafter, when determined that the clutch is in the disengaged position, the computing system may be configured to initiate one or more control actions, such as notifying the operator of the baler that the clutch is disengaged and/or adjusting or halting the speed of the agricultural baler.

Determining when the clutch of an agricultural baler is disengaged based on the rotational speed of the output shaft improves the operation of the agricultural baler. More specifically, operators may have difficulty determining when the clutch of an agricultural baler has become disengaged during baling operation, such as due to dusty conditions. As such, the disclosed system and method can automatically determine when the clutch is disengaged by using the rotational speed of the output shaft, thereby eliminating the need for the operator to determine when the clutch is disengaged.

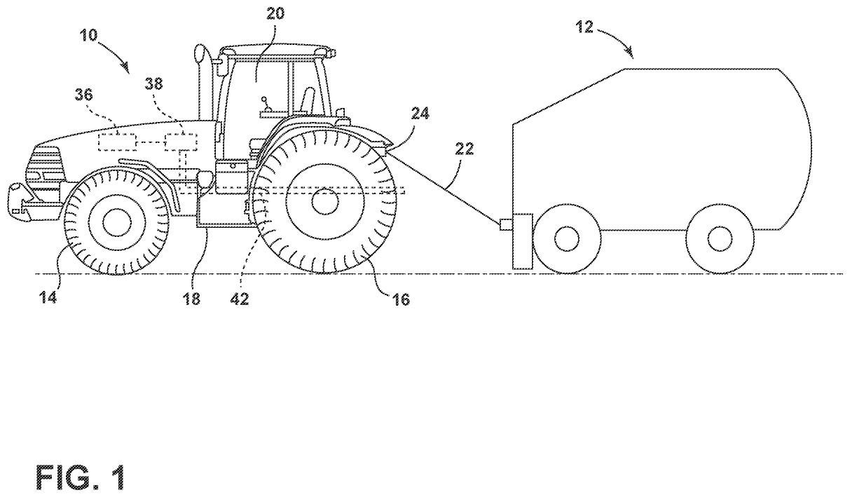

Referring now to the drawings, FIG. 1 illustrates a side view of one embodiment of a work vehicle 10 towing an agricultural baler 12 in accordance with aspects of the present subject matter. In general, the work vehicle 10 is configured to tow the baler 12 across the field in a direction of travel 44. As shown, in the illustrated embodiment, the work vehicle 10 is configured as an agricultural tractor. However, in other embodiments, the work vehicle 10 may correspond to any other suitable vehicle configured to tow a baler across a field.

As shown in FIG. 1, the work vehicle 10 includes a pair of front wheels 14, a pair or rear wheels 16 and a chassis 18 coupled to and supported by the wheels 14, 16. An operator's cab 20 may be supported by a portion of the chassis 18 and may house various input devices for permitting an operator to control the operation of the work vehicle 10 and/or the baler 12. Additionally, the work vehicle 10 may include an engine 36 and a transmission 38 mounted on the chassis 18. The transmission 38 may be operably coupled to the engine 36 and may provide variably adjusted gear ratios for transferring engine power to the wheels 16. Furthermore, the transmission 38 may be operably coupled to a power take-off shaft (PTO) 42. As will be described below, the baler 12 may be coupled to the PTO 42 such that the PTO 42 is configured to rotationally drive one or more components of the baler 12.

Additionally, the work vehicle 10 may be coupled to the baler 12 via a tongue 22 coupled to a hitch 24 of the work vehicle 10 to allow the vehicle 10 to tow the baler 12 across the field. As such, the work vehicle 10 may guide the baler 12 toward crop material deposited in windrows on the field to be collected by the baler 12.

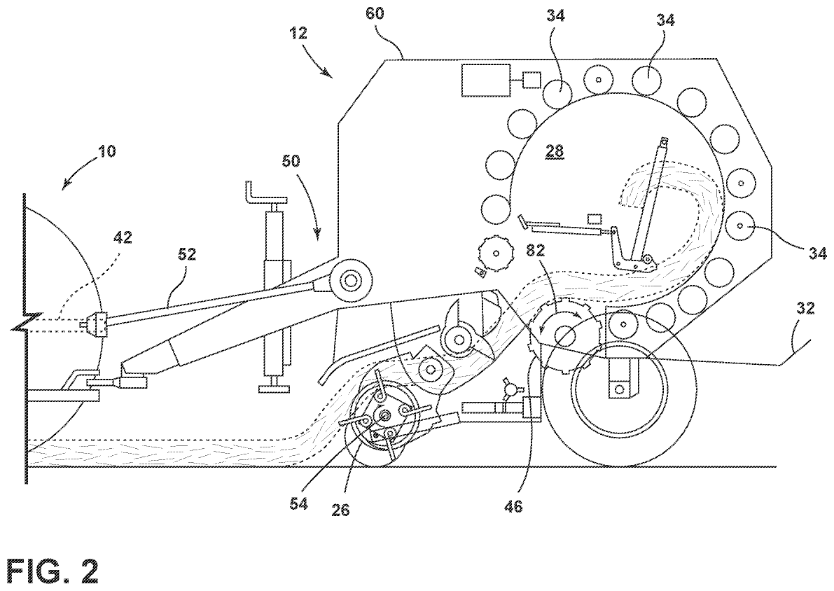

Referring now to FIG. 2, a cross-sectional side view of one embodiment of a work vehicle 10 and an agricultural baler 12 is illustrated in accordance with aspects of the present subject matter.

As shown in FIG. 2, the baler 12 includes a crop collector 26 mounted on the front end of the baler 12. The crop collector 26 may be, for example, a rotatable pickup reel that collects crop material from the ground and directs the crop toward a bale chamber 28 defined within a baler housing 60 of the baler 12. The crop collector 26 is rotatable in an operating direction for lifting the crop material off the ground. In general, the crop material is rolled into a bale of a predetermined size within the bale chamber 28 and is then discharged through a tailgate 32, movable between a closed position and an opened position, onto the field.

The baler 12 may include a plurality of carrier elements 34 within the bale chamber 28 and arranged around the bale chamber 28. The carrier element(s) 34 may be configured to engage and roll the bale as the crop material is directed into the bale chamber 28. As shown in FIG. 2, the carrier element(s) 34 are configured as roller(s). However, it should be appreciated that the carrier element(s) 34 may be configured as any suitable carrier element(s) configured to engage and roll the bale.

Furthermore, the baler 12 may include one or more carrier element gears 46 configured to be driven such that the carrier element(s) 34 engage and roll the bale as the crop material is directed into the bale chamber 28. As such, the carrier element gear(s) 46 may be configured to rotate (as indicated by arrow 82) when driven such that the carrier element(s) 34 engage and roll the bale. For example, as shown in FIG. 2, the carrier element gear(s) 46 is configured as a sprocket(s) rotatably driven by a chain(s). However, it should be appreciated that the carrier element gear 46 may be configured as any suitable gear, such as bevel, helical, spur, and/or the like, configured to be driven such that the carrier element(s) 34 engage and roll the bale.

Additionally, as shown in FIG. 2, the baler 12 includes a drive assembly 50. As will be described below, the drive assembly 50 is configured to rotationally drive the crop collector 26. In this respect, the drive assembly 50 includes a rotatable drive shaft 52 which may be mechanically coupled to the PTO 42 of the work vehicle 10 such that the PTO 42 rotationally drives the drive shaft 52, and an output shaft 54 coupled between the drive shaft 52 and the crop collector 26. The drive assembly 50 may also be configured to drive the carrier element(s) 34.

It should be appreciated that the configuration of the work vehicle 10 described above and shown in FIGS. 1 and 2 is provided only to place the present subject matter in an exemplary field of use. Thus, it should be appreciated that the present subject matter may be readily adaptable to any manner of work vehicle configuration.

Additionally, it should be appreciated that the configuration of the baler 12 described above and shown in FIGS. 1 and 2 is provided only to place the present subject matter in an exemplary field of use. Thus, it should be appreciated that the present subject matter may be readily adaptable to any manner of baler configuration. For example, as indicated above, the baler 12 may, in alternative embodiments, correspond to a square baler configured to generate square or rectangular bales.

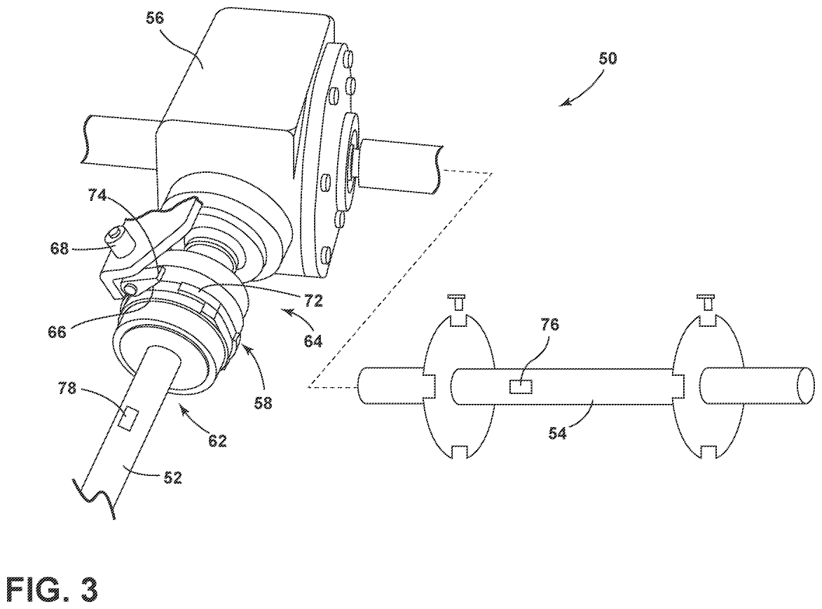

Referring now to FIG. 3, a perspective view of one embodiment of a drive assembly 50 of the agricultural baler 12 is illustrated in accordance with aspects of the present subject matter.

As mentioned previously, the drive assembly 50 is configured to rotationally drive the crop collector 26. As such, in addition to the drive shaft 52, the drive assembly 50 further includes a rotatable output shaft 54 coupled between the crop collector 26 (FIG. 2) and the drive shaft 52 and configured to rotationally drive the crop collector 26 (FIG. 2) and the carrier element(s) 34 (e.g., roller(s)).

Furthermore, the drive assembly 50 may include a gearbox 56 operably coupled between the drive shaft 52 and the output shaft 54 to redirect power from the drive shaft 52 to the output shaft 54. As such, the gearbox 56 is configured to rotate the output shaft 54 when the drive shaft 52 is rotating.

Additionally, the drive assembly 50 includes a clutch 58 coupled between the drive shaft 52 and the output shaft 54. The clutch 58 may include a first side 62 mechanically coupled to the drive shaft 52 and configured to rotate with the drive shaft 52. The clutch 58 may also include a second side 64 mechanically coupled to the gearbox 56 and configured to be mechanically coupled to the first side 62. In some embodiments, the first side 62 of the clutch 58 includes a pawl 66 and an actuator 68. The second side 64 includes a protrusion 72 for contacting the pawl 66. As will be described below, the pawl 66, the actuator 68, and the protrusion 72 allow the first side 62 and the second side 64 to be mechanically coupled and decoupled from each other.

The clutch 58 may be configured to selectively couple and decouple the drive shaft 52 and the output shaft 54. As such, the clutch 58 may be moveable between an engaged position, in which the drive shaft 52 is mechanically coupled to the output shaft 54, and a disengaged position, in which the drive shaft 52 is mechanically decoupled from the output shaft 54. In this respect, the first side 62 and the second side 64 of the clutch 58 may be mechanically coupled to each other when the clutch 58 is in the engaged position. For example, in some embodiments, when moving from the disengaged position to the engaged position, the actuator 68 may engage and move the pawl 66 toward the protrusion 72 of the second side 64. The pawl 66 may have a protruded end 74 such that, when the pawl 66 moves toward the protrusion 72 of the second side 64, the protruded end 74 contacts the protrusion 72 to couple the first side 62 and the second side 64 together. Alternatively, the first side 62 and the second side 64 may be mechanically decoupled from each other when the clutch 58 is in the disengaged position. For example, in some embodiments, the actuator 68 may disengage and move the pawl 66 away from the protrusion 72 of the second side 64 such that the pawl 66 is prevented from contacting the protrusion 72. During baling operations, the baler 12 may become plugged/jammed such that the clutch 58 is moved to the disengaged position. However, it should be appreciated that the clutch 58 may be configured in any other suitable manner such that the clutch 58 is moveable between the engaged position and the disengaged position.

Additionally, the baler 12 includes one or more first sensors 76 coupled thereto and/or supported thereon. In general, the first sensor(s) 76 is configured to generate data indicative of the rotational movement, such as the rotational speed, of the output shaft 54, which may be rotated when the clutch 58 is in the engaged position.

In general, the first sensor(s) 76 may correspond to any suitable device(s) configured to generate data indicative of the rotational movement of the output shaft 54. For example, in several embodiments, the first sensor(s) 76 may be configured as an accelerometer, magnetic sensor, and/or the like configured to generate data indicative of the rotational movement of the output shaft 54. However, in alternative embodiments, the first sensor(s) 76 may be configured as any other suitable device(s) for generating data indicative of the rotational movement of the output shaft 54.

Furthermore, the baler 12 may include any number of first sensors 76 provided at any suitable locations that allows data indicative of the rotational movement of the output shaft 54 to be generated as the baler 12 and the work vehicle 10 traverse the field. In this respect, FIG. 3 illustrates example locations for mounting the first sensor(s) 76 for generating data indicative of the rotational movement of the output shaft 54. For example, as shown in FIG. 3, the first sensor(s) 76 is mounted on the output shaft 54. In this respect, the first sensor(s) 76 may generate data indicative of the rotational movement of the output shaft 54. However, in alternative embodiments, the first sensor(s) 76 may be installed at any other suitable location(s) that allows the device(s) to generate data indicative of the rotational movement of the output shaft 54.

Additionally, the baler 12 includes one or more second sensors 78 coupled thereto and/or supported thereon. In general, the second sensor(s) 78 is configured to generate data indicative of a rotational movement, such as a rotational speed, of the drive shaft 52, which may be rotated when the clutch 58 is in either the engaged position or the disengaged position.

In general, the second sensor(s) 78 may correspond to any suitable device(s) configured to generate data indicative of the rotational movement of the drive shaft 52. For example, in several embodiments, the second sensor(s) 78 may be configured as an accelerometer, magnetic sensor, and/or the like configured to generate data indicative of the rotational movement of the drive shaft 52. However, in alternative embodiments, the second sensor(s) 78 may be configured as any other suitable device(s) for generating data indicative of the rotational movement of the drive shaft 52.

Furthermore, the baler 12 may include any number of second sensors 78 provided at any suitable locations that allows data indicative of the rotational movement of the drive shaft 52 to be generated as the baler 12 and the work vehicle 10 traverse the field. In this respect, FIG. 3 illustrates example locations for mounting the second sensor(s) 78 for generating data indicative of the rotational movement of the drive shaft 52. For example, as shown in FIG. 3, the second sensor 78 is mounted on the drive shaft 52. In this respect, the second sensor 78 may generate data indicative of the rotational movement of the drive shaft 52. However, in alternative embodiments, the second sensor(s) 78 may be installed at any other suitable location(s) that allows the device(s) to generate data indicative of the rotational movement of the drive shaft 52.

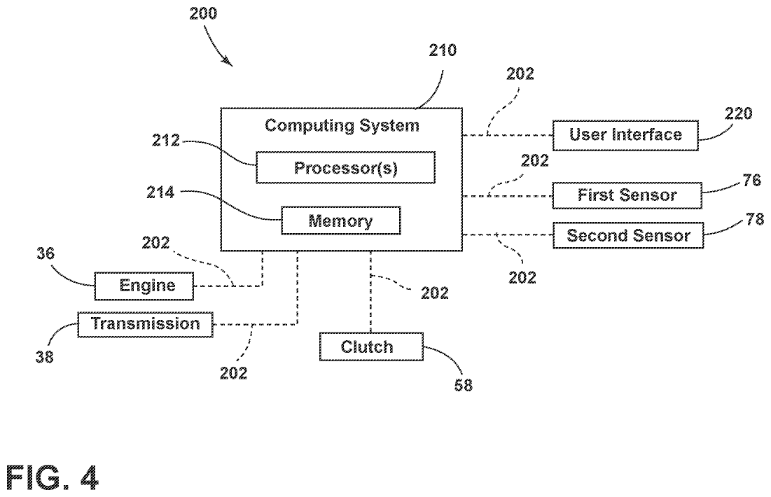

Referring now to FIG. 4, a schematic view of one embodiment of a system 200 for determining the clutch status of an agricultural baler is illustrated in accordance with aspects of the present subject matter. In general, the system 200 will be described herein with reference to the work vehicle 10 and the baler 12 described above with reference to FIGS. 1-3. However, it should be appreciated that the disclosed system 200 may generally be utilized with work vehicles having any suitable vehicle configuration and/or balers have any suitable baler configuration.

As shown in FIG. 4, the system 200 includes a computing system 210 communicatively coupled to one or more components of the agricultural baler 12, the work vehicle 10, and/or the system 200 to allow the operation of such components to be electronically or automatically controlled by the computing system 210. For instance, the computing system 210 may be communicatively coupled to the first and second sensors 76, 78 via a communicative link 202. As such, the computing system 210 may be configured to receive data from the first sensor(s) 76 that is indicative of the rotational movement of the output shaft 54 of the drive assembly 50 of the baler 12. Likewise, the computing system 210 may be configured to receive data from the second sensor(s) 78 that is indicative of the rotational movement of the drive shaft 52 of the drive assembly 50 of the baler 12. Moreover, the computing system 210 may be communicatively coupled to the clutch 58 of the drive assembly 50 via the communicative link 202. In this respect, the computing system 210 may be configured to control the operation of the clutch 58, such as the operation of the actuator 68, to move the clutch 58 between the engaged position and the disengaged position. Furthermore, the computing system 210 may be communicatively coupled to the engine 36 and/or the transmission 38 of the work vehicle 10 via the communicative link 202. In this respect, the computing system 210 may be configured to control the operation of the engine 36 and/or the transmission 38 to adjust the ground speed at which the work vehicle 10 and, thus, the baler 12 travels across the field. In addition, the computing system 210 may be communicatively coupled to any other suitable components of the baler 12, the work vehicle 10, and/or the system 200.

In general, the computing system 210 may comprise any suitable processor-based device known in the art, such as a given controller or computing device or any suitable combination of controllers or computing devices. Thus, in several embodiments, the computing system 210 may include one or more processor(s) 212 and associated memory device(s) 214 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 214 of the computing system 210 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 214 may generally be configured to store suitable computer-readable instructions that, when implemented by the processor(s) 212, configure the computing system 210 to perform various computer-implemented functions, such as one or more aspects of the methods and algorithms that will be described herein. In addition, the computing system 210 may also include various other suitable components, such as a communications circuit or module, one or more input/output channels, a data/control bus and/or the like.

It should be appreciated that the computing system 210 may correspond to an existing computing system(s) of the baler 12 and/or the work vehicle 10, itself, or the computing system 210 may correspond to a separate processing device. For instance, in one embodiment, the computing system 210 may form all or part of a separate plug-in module that may be installed in association with the baler 12 and/or the work vehicle 10 to allow for the disclosed systems to be implemented without requiring additional software to be uploaded onto existing control devices of the baler 12 and/or the work vehicle 10.

Furthermore, it should also be appreciated that the functions of the computing system 210 may be performed by a single processor-based device or may be distributed across any number of processor-based devices, in which instance such devices may be considered to form part of the computing system 210. For instance, the functions of the computing system 210 may be distributed across multiple application-specific controllers or computing devices, such as a navigation controller, an engine computing controller, a transmission controller, an implement controller and/or the like.

In addition, the system 200 may also include a user interface 220. More specifically, the user interface 220 may be configured to provide feedback, such as feedback associated with the engagement and disengagement of the clutch 58, to the operator. As such, the user interface 220 may include one or more feedback devices (not shown), such as display screens, speakers, warning lights, and/or the like, which are configured to provide feedback from the computing system 210 to the operator. As such, the user interface 220 may, in turn, be communicatively coupled to the computing system 210 via the communicative link 202 to permit the feedback to be transmitted from the computing system 210 to the user interface 220. Furthermore, some embodiments of the user interface 220 may include one or more input devices, such as touchscreens, keypads, touchpads, knobs, buttons, sliders, switches, mice, microphones, and/or the like, which are configured to receive inputs from the operator. In one embodiment, the user interface 220 may be mounted or otherwise positioned within the operator's cab 20 of the work vehicle 10. However, in alternative embodiments, the user interface 220 may mounted at any other suitable location.

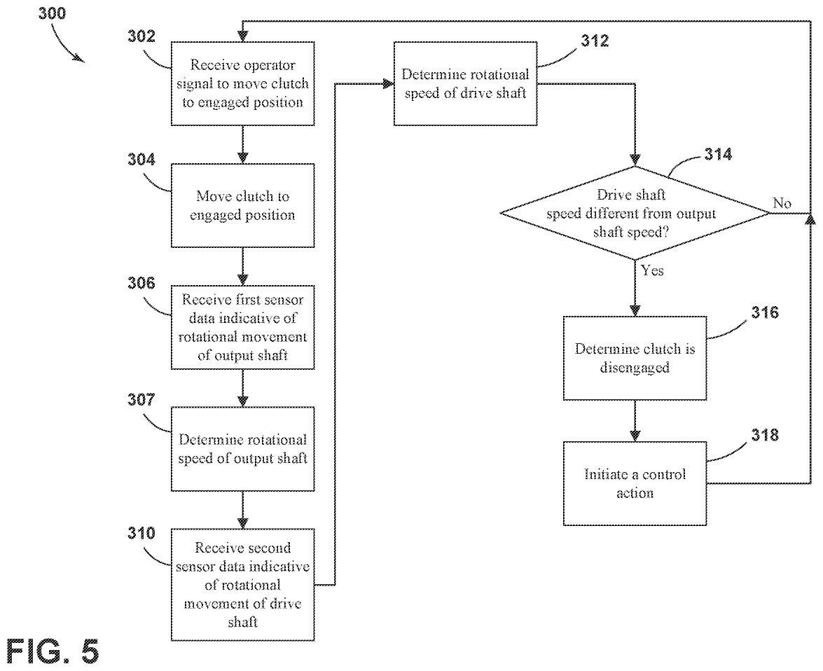

Referring now to FIG. 5, a flow diagram of one embodiment of control logic 300 that may be executed by the computing system 210 (or any other suitable computing system) for determining the clutch status of an agricultural baler is illustrated in accordance with aspects of the present subject matter. Specifically, the control logic 300 shown in FIG. 5 is representative of steps of one embodiment of an algorithm that can be executed to determine the clutch status of an agricultural baler. Thus, in several embodiments, the control logic 300 may be advantageously utilized in association with a system installed on or forming part of an agricultural baler to allow for real-time identification of the clutch status of the baler without requiring substantial computing resources and/or processing time. However, in other embodiments, the control logic 300 may be used in association with any other suitable system, application, and/or the like for determining the clutch status of an agricultural baler.

As shown in FIG. 5, at (302), the control logic 300 includes receiving an operator input to move a clutch of a drive assembly of an agricultural baler to an engaged position. Specifically, as mentioned above, in several embodiments, the computing system 210 may be communicatively coupled to the user interface 220 via the communicative link 202. In this respect, the computing system 210 may receive an operator input from the user interface 220, to move the clutch 58 to the engaged position.

Moreover, after receipt of the operator input, at (304), the control logic 300 includes moving the clutch to the engaged position. Specifically, as mentioned above, in several embodiments, the computing system 210 may be communicatively coupled to the clutch 58 via the communicative link 202. In this respect, after receipt of the operator input at (302), the computing system 210 may move the clutch 58 to the engaged position.

Additionally, after receipt of the operator input, at (306), the control logic 300 includes receiving first sensor data indicative of a rotational movement of an output shaft of a drive assembly of an agricultural baler. Specifically, as mentioned above, in several embodiments, the computing system 210 may be communicatively coupled to the first sensor(s) 76 via the communicative link 202. In this respect, after receipt of the operator input at (302), the computing system 210 may receive data from the first sensor(s) 76. Such data may, in turn, be indicative of the rotational movement of the output shaft 54.

Furthermore, as shown in FIG. 5, at (308), the control logic 300 includes determining a rotational speed of the output shaft of the drive assembly of the agricultural baler based on the received first sensor data. In this respect, in several embodiments, the computing system 210 may be configured to determine the rotational speed of the output shaft 54 based on the first sensor data received at (306).

Moreover, at (310), the control logic 300 includes, after receipt of the operator input at (302), receiving second sensor data indicative of a rotational movement of a drive shaft of a drive assembly of an agricultural baler. Specifically, as mentioned above, in several embodiments, the computing system 210 may be communicatively coupled to the second sensor(s) 78 via the communicative link 202. In this respect, after receipt of the operator input at (302), the computing system 210 may receive data from the second sensor(s) 78. Such data may, in turn, be indicative of the rotational movement of the drive shaft 52.

Additionally, at (312), the control logic 300 includes, after receipt of the operator input at (302), determining a rotational speed of the drive shaft of the drive assembly of the agricultural baler based on the received second sensor data. In this respect, in several embodiments, the computing system 210 may be configured to determine a rotational speed of the drive shaft 52.

Furthermore, as shown in FIG. 5, at (314), the control logic 300 includes comparing the determined rotational speed of the output shaft to the determined rotational speed of the drive shaft. During baling operations, when the agricultural baler 12 experiences a plug/jam, the clutch 58 of the drive assembly 50 may be moved to the disengaged position. As a result, the drive shaft 52 and the output shaft 54 may not move at the same rotational speed. For example, the output shaft 54 may be moving at a slower rotational speed than the drive shaft 52, or the rotational speed of the drive shaft 52 may exceed zero while the rotational speed of the output shaft 54 is zero. As such, in several embodiments, the computing system 210 may be configured to compare the determined rotational speeds of the drive shaft 52 and the output shaft 54.

In this respect, in one embodiment, comparing the determined rotational speed of the output shaft 54 to the determined rotational speed of the drive shaft 52 may include determining when the rotational speed of the drive shaft 52 determined at (312) exceeds the rotational speed of the output shaft 54 determined at (308) by a predetermined threshold. The predetermined threshold may be a minimum value indicative of the clutch 58 being in the disengaged position. As such, when the determined that the determined rotational speed of the drive shaft 52 exceeds the determined rotational speed of the output shaft 54 by the predetermined threshold, the control logic 300 proceeds to (316). Otherwise, the control logic 300 returns to (302).

In a different embodiment, comparing the determined rotational speed of the output shaft 54 to the determined rotational speed of the drive shaft 52 may include when the rotational speed of the drive shaft 52 determined at (312) exceeds zero and the rotational speed of the output shaft 54 determined at (308) is zero. As such, when the rotational speed of the drive shaft 52 exceeds zero and the rotational speed of the output shaft 54 is zero, the control logic 300 proceeds to (316). Otherwise, the control logic 300 returns to (302).

However, it should be appreciated that, in some embodiments, determining when the clutch 58 is in the disengaged position may be based on the rotational speed of the output shaft 54 alone, without comparison to the rotational speed of the drive shaft 52.

Moreover, as shown in FIG. 5, at (316), the control logic 300 includes determining that the clutch is in the disengaged position. As such, the computing system 210 may be configured to determine that the clutch 58 is in the disengaged position when the comparison at (314) results in, for example, the rotational speed of the drive shaft 52 exceeding the rotational speed of the output shaft 54 by the predetermined threshold, or the rotational speed of the drive shaft 52 exceeding zero and the rotational speed of the output shaft 54 is zero.

Furthermore, as shown in FIG. 5, at (318), the control logic 300 includes initiating one or more control actions when it is determined that the clutch is in the disengaged position. Specifically, in one embodiment, the computing system 210 may be configured to provide a notification to an operator of the work vehicle 10 and/or agricultural baler 12 that the clutch 58 is in the disengaged position. Specifically, the computing system 210 may be configured to transmit instructions to the user interface 220 (e.g., via the communicative link 202) instructing the user interface 220 to provide a notification to the operator of the work vehicle 10 and/or baler 12 (e.g., by causing a visual notification or indicator to be presented to the operator) indicating that the clutch 58 is in the disengaged position.

Alternatively, or additionally, at (318), the computing system 210 may be configured to automatically adjust the ground speed at which the work vehicle 10 and/or baler 12 is traveling across the field when it is determined that the clutch 58 is in the disengaged position. Specifically, the computing system 210 may be configured to transmit instructions to the engine 36 and/or the transmission 38 (e.g., via the communicative link 202) instructing the engine 36 and/or the transmission 38 to adjust their operation. For example, the computing system 210 may instruct the engine 36 to vary its power output and/or the transmission 38 to upshift or downshift to increase or decrease the ground speed and/or stop/halt movement of the work vehicle 10 and/or the baler 12. However, in alternative embodiments, the computing system 210 may be configured to transmit instructions to any other suitable components (e.g., braking actuators) of the work vehicle 10 and/or the baler 12 such that the ground speed of the work vehicle 10 and/or the baler 12 is adjusted. Furthermore, it should be appreciated that any other suitable parameter(s) the work vehicle 10 and/or the baler 12 may be adjusted when it is determined that the clutch 58 is in the disengaged position. Upon completion of (318), the control logic 300 returns to (302).

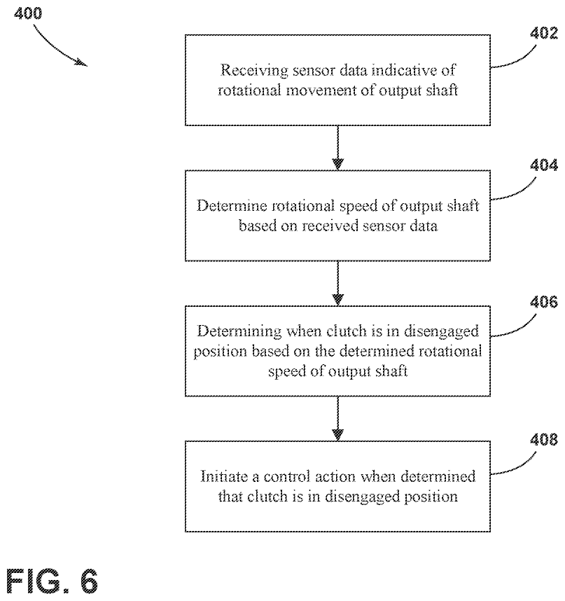

Referring now to FIG. 6, a flow diagram of one embodiment of a method 400 for determining the clutch status of an agricultural baler is illustrated in accordance with aspects of the present subject matter. In general, the method 400 will be described herein with reference to the agricultural baler 12 and the work vehicle 10 shown in FIGS. 1-3 and the system 200 described with reference to FIGS. 4 and 5. However, it should be appreciated that the disclosed method 400 may be implemented with work vehicles and/or agricultural balers having any other suitable configurations and/or within systems having any other suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 6, at (402), the method 400 may include receiving sensor data indicative of a rotational movement of an output shaft. For instance, as indicated above, in several embodiments, the computing system 210 may be communicatively coupled to the first sensor(s) 76 configured to generate data indicative of a rotational movement of the output shaft 54 of the drive assembly 50 of the agricultural baler 12. As such, the computing system 210 may be configured to receive the first sensor data indicative of the rotational movement of the output shaft 54 from the first sensor(s) 76.

Additionally, at (404), the method 400 may include determining a rotational speed of the output shaft based on the received sensor data. For instance, as indicated above, in several embodiments, the computing system 210 may be configured to determine the rotational speed of the output shaft 54 based on the received first sensor data.

Moreover, at (406), the method 400 may include determining when a clutch is in a disengaged position in which the drive shaft is mechanically decoupled from the output shaft based on the determined rotational speed of the output shaft. A For instance, as indicated above, in several embodiments, the computing system 210 may be configured to determine when the clutch 58 is in the disengaged position in which the drive shaft 52 is mechanically decoupled from the output shaft 54 based on the determined rotational speed of the output shaft 54.

Furthermore, at (408), the method 400 may include initiating a control action when determined that the clutch is in the disengaged position. For instance, as indicated above, in several embodiments, the computing system 210 may be communicatively coupled to the user interface 220 and the engine 36 and/or the transmission 38 of the work vehicle 10. As such, the computing system 210 may be configured to notify the operator of the work vehicle 10 and/or the baler 12 via the user interface 220 that the clutch 58 is in the disengaged position. Furthermore, the computing system 210 may be configured to slow or halt movement of the work vehicle 10, and, thus, the baler 12, by controlling an operation of the engine 36 and/or transmission 38 of the work vehicle 10.

It is to be understood that the steps of the control logic 300 and the method 400 are performed by the computing system 210 upon loading and executing software code or instructions which are tangibly stored on one or more tangible computer readable media, such as one or more magnetic media (e.g., a computer hard drive(s)), one or more optical media (e.g., an optical disc(s)), solid-state memory (e.g., flash memory), and/or other storage media known in the art. Thus, any of the functionality performed by the computing system 210 described herein, such as the control logic 300 and the method 400, is implemented in software code or instructions which are tangibly stored on one or more tangible computer readable media. The computing system 210 loads the software code or instructions via a direct interface with the one or more computer readable media or via a wired and/or wireless network. Upon loading and executing such software code or instructions by the computing system 210, the computing system 210 may perform any of the functionality of the computing system 210 described herein, including any steps of the control logic 300 and the method 400 described herein.

The term “software code” or “code” used herein refers to any instructions or set of instructions that influence the operation of a computing system, such as one or more computers or one or more controllers. They may exist in a computer-executable form, such as machine code, which is the set of instructions and data directly executed by a computing system's central processing unit(s) or by a controller(s), a human-understandable form, such as source code, which may be compiled in order to be executed by a computing system's central processing unit(s) or by a controller(s), or an intermediate form, such as object code, which is produced by a compiler. As used herein, the term “software code” or “code” also includes any human-understandable computer instructions or set of instructions (e.g., a script), that may be executed on the fly with the aid of an interpreter executed by a computing system's central processing unit(s) or by a controller(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A system for determining the clutch status of an agricultural baler, the system comprising:
a crop collector configured to lift crop material from a field surface;
a drive assembly configured to rotationally drive the crop collector, the drive assembly comprising:
a drive shaft;
an output shaft coupled between the crop collector and the drive shaft; and
a clutch coupled between the drive shaft and the output shaft, the clutch being moveable between an engaged position and a disengaged position such that, when the clutch is in the engaged position, the drive shaft is mechanically coupled to the output shaft and, when the clutch is in the disengaged position, the drive shaft is mechanically decoupled from the output shaft;
a sensor configured to generate data indicative of a rotational movement of the output shaft; and
a computing system communicatively coupled to the sensor, the computing system being configured to:
determine a rotational speed of the output shaft based on the data generated by the sensor; and
determine when the clutch is in the disengaged position based on the determined rotational speed of the output shaft.

2. The system of claim 1, wherein the sensor corresponds to a first sensor, the system further comprising:
a second sensor configured to generate data indicative of a rotational movement of the drive shaft,
wherein the computing system is further communicatively coupled to the second sensor, the computing system being further configured to:
determine a rotational speed of the drive shaft based on the data generated by the second sensor; and
determine when the clutch is in the disengaged position based on the determined rotational speed of the drive shaft and the determined rotational speed of the output shaft.

3. The system of claim 2, wherein, when determining when the clutch is in the disengaged position, the computing system is further configured to:
compare the determined rotational speed of the output shaft to the determined rotational speed of the drive shaft; and
determine that the clutch is in the disengaged position when the determined rotational speed of the drive shaft exceeds the determined rotational speed of the output shaft by a predetermined threshold.

4. The system of claim 2, wherein, when determining when the clutch is in the disengaged position, the computing system is further configured to:
determine that the clutch is in the disengaged position when the rotational speed of the drive shaft exceeds zero and the rotational speed of the output shaft is zero.

5. The system of claim 2, wherein the computing system is further configured to:
receive an operator input to move the clutch to the engaged position;
after receipt of the operator input, move the clutch to the engaged position;
after receipt of the operator input, determine the rotational speed of the output shaft based on the data generated by the sensor;
after receipt of the operator input, determine the rotational speed of the drive shaft based on the data generated by the second sensor; and
after receipt of the operator input, determine that the clutch is in the disengaged position when the rotational speed of the drive shaft exceeds zero and the output shaft is zero.

6. The system of claim 1, the computing system being further configured to initiate a control action when it is determined that the clutch is in the disengaged position.

7. The system of claim 6, wherein the control action comprises notifying an operator of the agricultural baler that the clutch is in the disengaged position.

8. The system of claim 6, wherein the control action comprises adjusting a ground speed of the agricultural baler.

9. The system of claim 8, wherein the control action comprises halting movement of the agricultural baler.

10. A method for determining the clutch status of an agricultural baler, the agricultural baler including a crop collector configured to lift crop material from a field surface, the agricultural baler further including a drive assembly configured to rotationally drive the crop collector, the drive assembly including a drive shaft and an output shaft coupled between the crop collector and the drive shaft, the method comprising:
receiving, with a computing system, sensor data indicative of a rotational movement of the output shaft;
determining, with the computing system, a rotational speed of the output shaft based on the received sensor data;
determining, with the computing system, when a clutch, moveable between an engaged position in which the drive shaft is mechanically coupled to the output shaft and a disengaged position in which the drive shaft is mechanically decoupled from the output shaft, is in the disengaged position based on the determined rotational speed of the output shaft; and
initiating, with the computing system, a control action when it is determined that the clutch is in the disengaged position.

11. The method of claim 10, wherein the sensor data corresponds to first sensor data, the method further comprising:
receiving, with the computing system, second sensor data indicative of a rotational movement of the drive shaft;
determining, with the computing system, a rotational speed of the drive shaft based on the received second sensor data;
determining, with the computing system, when the clutch is in the disengaged position based on the determined rotational speed of the drive shaft and the determined rotational speed of the output shaft; and
initiating, with the computing system, a control action when it is determined that the clutch is in the disengaged position.

12. The method of claim 11, wherein, when determining when the clutch is in the disengaged position, the method further comprises:
comparing, with the computing system, the determined rotational speed of the output shaft to the determined rotational speed of the drive shaft;
determining, with the computing system, that the clutch is in the disengaged position when the determined rotational speed of the drive shaft exceeds the determined rotational speed of the output shaft by a predetermined threshold; and
initiating, with the computing system, a control action when it is determined that the clutch is in the disengaged position.

13. The method of claim 12, wherein, when determining when the clutch is in the disengaged position, the method further comprises:
determining, with the computing system, that the clutch is in the disengaged position when the rotational speed of the drive shaft exceeds zero and the rotational speed of the output shaft is zero; and
initiating, with the computing system, a control action when it is determined that the clutch is in the disengaged position.

14. The method of claim 12, further comprising:
receiving, with the computing system, an operator input to move the clutch to the engaged position;
after receipt of the operator input, moving, with the computing system, the clutch to the engaged position;
after receipt of the operator input, determining, with the computing system, the rotational speed of the output shaft based on the data generated by the sensor;
after receipt of the operator input, determining, with the computing system, the rotational speed of the drive shaft based on the data generated by the second sensor;
after receipt of the operator input, determining, with the computing system, that the clutch is in the disengaged position when the rotational speed of the drive shaft exceeds zero and the rotational speed of the output shaft is zero; and
initiating, with the computing system, a control action when it is determined that the clutch is in the disengaged position.

15. The method of claim 10, wherein initiating, with the computing system, a control action when determined that the clutch is in the disengaged position comprises:
notifying, with the computing system, an operator of the agricultural baler that the clutch is in the disengaged position.

16. The method of claim 10, wherein initiating, with the computing system, a control action when determined that the clutch is in the disengaged position comprises:
adjusting, with the computing system, a ground speed of the agricultural baler.

17. The method of claim 16, wherein adjusting, with the computing system, a ground speed of the agricultural baler comprises:
halting, with the computing system, movement of the agricultural baler.

18. An agricultural baler, comprising:
a crop collector configured to lift crop material from a field surface;
a bale housing defining a bale chamber therein;
a plurality of carrier elements within the bale chamber configured to form a bale of the lifted crop material;
a drive assembly configured to rotationally drive the crop collector, the drive assembly comprising:
a drive shaft;
an output shaft coupled between the crop collector and the drive shaft; and
a clutch coupled between the drive shaft and the output shaft, the clutch being moveable between an engaged position and a disengaged position such that, when the clutch is in the engaged position, the drive shaft is mechanically coupled to the output shaft and, when the clutch is in the disengaged position, the drive shaft is mechanically decoupled from the output shaft;
a sensor configured to generate data indicative of a rotational movement of the output shaft; and
a computing system communicatively coupled to the sensor, the computing system being configured to:
determine a rotational speed of the output shaft based on the data generated by the sensor; and
determine when the clutch is in the disengaged position based on the determined rotational speed of the output shaft.

19. The agricultural baler of claim 18, wherein the sensor corresponds to a first sensor, the system further comprising:
a second sensor configured to generate data indicative of a rotational movement of the drive shaft, and
wherein, the computing system is communicatively coupled to the second sensor, the computing system being further configured to:
determine a rotational speed of the drive shaft based on the data generated by the second sensor; and
determine when the clutch is in the disengaged position based on the determined rotational speed of the drive shaft and the determined rotational speed of the output shaft.

20. The agricultural baler of claim 19, wherein, when determining when the clutch is in the disengaged position, the computing system is further configured to:
compare the determined rotational speed of the output shaft to the determined rotational speed of the drive shaft; and
determine that the clutch is in the disengaged position when the determined rotational speed of the drive shaft exceeds the determined rotational speed of the output shaft by a predetermined threshold.
